(19) United States
(12) Patent Application Publication
(10) Pub. No.: US 2024/0421392 A1
(43) Pub. Date: Dec. 19, 2024

(54) POWER STORAGE CELL

(71) Applicant: TOYOTA JIDOSHA KABUSHIKI KAISHA, Toyota-shi (JP)

(72) Inventors: Yosuke SHIMURA, Toyota-shi (JP); Yoshiro OBAYASHI, Toyota-shi (JP); Atsushi YAMANAKA, Nagoya-shi (JP); Masashi CHIHARA, Nagoya-shi (JP); Kazuki SUGIE, Miyoshi-shi (JP); Kosuke YONEKAWA, Nisshin-shi (JP); Yasuhiro HIRAO, Toyota-shi (JP)

(73) Assignee: TOYOTA JIDOSHA KABUSHIKI KAISHA, Toyota-shi (JP)

(21) Appl. No.: 18/659,780

(22) Filed: May 9, 2024

(30) Foreign Application Priority Data
Jun. 14, 2023 (JP) 2023-097626

(51) Int. Cl. H01M 50/136; H01M 50/103; H01M 50/169

(52) U.S. Cl. CPC H01M 50/136; H01M 50/103; H01M 50/169

(57) ABSTRACT

In a power storage cell, a case includes a bottom portion, first and second side surface portions, first and second end face portions, a welding portion, and a rib. The first side surface portion extends upright from the bottom portion. The second side surface portion extends upright from the bottom portion and faces the first side surface portion. The first end face portion extends from the first side surface portion in a direction in which the first side surface portion faces the second side surface portion. The second end face portion extends from the second side surface portion in a direction in which the second side surface portion faces the first side surface portion. The welding portion connects the first and second end face portions to each other. The rib is located along a corner edge formed by the first side surface portion and the first end face portion.

### CROSS REFERENCE TO RELATED APPLICATIONS

This nonprovisional application is based on Japanese Patent Application No. 2023-097626 filed on Jun. 14, 2023 with the Japan Patent Office, the entire contents of which are hereby incorporated by reference.

### BACKGROUND

### Field

The present disclosure relates to a power storage cell.

### Description of the Background Art

Japanese Patent Laying-Open No. 2013-125737 discloses a secondary battery. The secondary battery includes an electrode assembly and a case that houses the electrode assembly. The case has a horizontally long rectangular plate shape, and includes a main body and a lid. The main body is formed by bending one metal plate and welding edges of the bent metal plate. The metal plate includes a bottom surface portion, a pair of side surface portions, and four half end face portions. The half end face portions are connected to respective shorter sides of a pair of side surface portions. The edges of the half end face portions opposed to each other are abutted and joined by welding.

### SUMMARY

When the edges of the half end face portions are welded to each other as disclosed in Japanese Patent Laying-Open No. 2013-125737, there is a possibility that the case is distorted by welding.

It is an object of the present disclosure to provide a power storage cell in which distortion of a case due to welding of end faces is suppressed.

A power storage cell according to the present disclosure includes an electrode assembly, and a case housing the electrode assembly. The case includes a bottom portion, a first side surface portion, a second side surface portion, a first end face portion, a second end face portion, a welding portion, and a rib. The first side surface portion extends upright from the bottom portion. The second side surface portion extends upright from the bottom portion and faces the first side surface portion. The first end face portion extends from the first side surface portion in a direction in which the first side surface portion faces the second side surface portion. The second end face portion extends from the second side surface portion in a direction in which the second side surface portion faces the first side surface portion. The welding portion connects the first end face portion and the second end face portion to each other. The rib is located along a corner edge formed by the first side surface portion and the first end face portion.

According to the above configuration, the rigidity of the corner edge is increased by the rib. Accordingly, when the first end face portion and the second end face portion are welded to form the welding portion, distortion of the first side surface portion due to deformation of the first end face portion to be welded can be suppressed. Therefore, it is possible to provide a power storage cell in which distortion of the case due to welding of the end faces is suppressed.

In the power storage cell of the present disclosure, preferably the welding portion extends in a height direction. The height direction is a direction in which the first side surface portion extends upright. The rib extends in the height direction.

According to the above configuration, the rigidity of the corner edge can be further increased by the rib. Even when the first end face portion and the second end face portion are welded along the height direction, distortion of the first side surface portion due to deformation of the first end face portion to be welded can be effectively suppressed. Therefore, it is possible to provide a power storage cell in which distortion of the case due to welding of the end faces is further suppressed.

In the power storage cell of the present disclosure, preferably the rib protrudes inward of the case from the corner edge.

According to the above configuration, it is possible to increase the rigidity of the corner edge while suppressing an increase in the size of the case.

In the power storage cell of the present disclosure, preferably the rib protrudes outward of the case from the corner edge.

According to the above configuration, it is possible to increase the rigidity of the corner edge while suppressing reduction of the size of the space inside the case.

In the power storage cell of the present disclosure, preferably the welding portion extends in a height direction. The height direction is a direction in which the first side surface portion extends upright. The rib extends in the height direction. The rib protrudes both inward and outward of the case from the corner edge.

According to the above configuration, the rigidity of the corner edge can be further increased by the rib, and even when the first end face portion and the second end face portion are welded along the height direction, distortion of the first side surface portion due to deformation of the first end face portion to be welded can be effectively suppressed. Therefore, it is possible to provide a power storage cell in which distortion of the case due to welding of the end faces is further suppressed. Further, it is possible to prevent the space inside the case from becoming too small. Further, the case can be prevented from becoming too large. Further, the rigidity of the corner edge can be increased.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage cell according to an embodiment of the present disclosure.

FIG. 2 is a cross-sectional view of the power storage cell of FIG. 1 taken along a line II-II.

FIG. 3 is a cross-sectional view of an electrode assembly of FIG. 2 as seen from the direction of arrows III-III.

FIG. 4 is a perspective view showing a case according to an embodiment of the present disclosure from one side.

FIG. 5 is a perspective view showing the case according to an embodiment of the present disclosure from the other side.

FIG. 6 is a schematic perspective view showing a state before each member constituting the case is welded.

### DESCRIPTION OF THE PREFERRED EMBODIMENTS

Embodiments of the present disclosure will be described with reference to the drawings. In the drawings referred to below, the same or corresponding members are denoted by the same reference numerals.

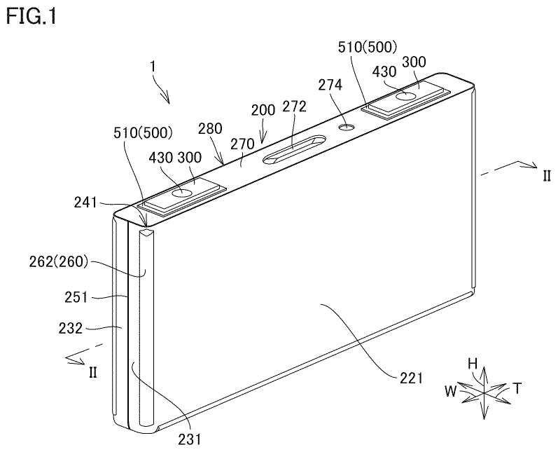

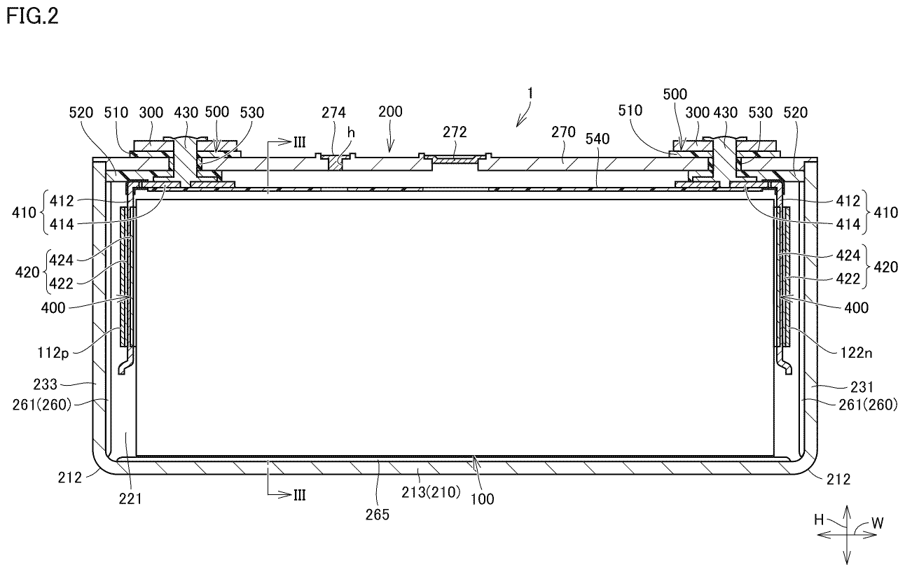

FIG. 1 is a perspective view showing a power storage cell according to an embodiment of the present disclosure. FIG. 2 is a cross-sectional view of the power storage cell of FIG. 1 taken along a line II-II.

As shown in FIGS. 1 and 2, the power storage cell 1 includes an electrode assembly 100, a case 200, a pair of external terminals 300, a pair of connecting members 400, and an insulating member 500.

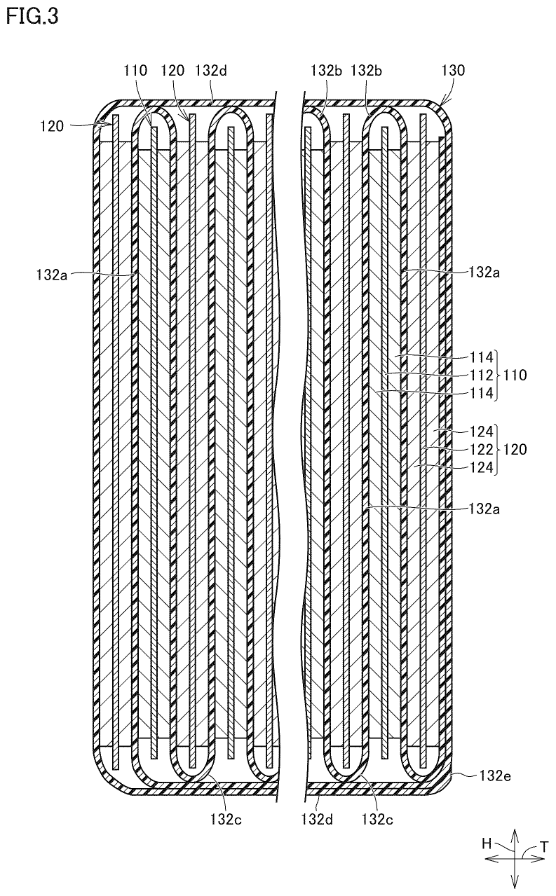

FIG. 3 is a cross-sectional view of the electrode assembly of FIG. 2 as seen from the direction of arrows III-III. As shown in FIG. 3, the electrode assembly 100 includes a plurality of electrodes 110 and 120 and a separator 130.

As shown in FIG. 3, the electrodes 110 and 120 are arranged side by side in the thickness direction T. In this embodiment, the thickness direction T is orthogonal to the height direction H. The plurality of electrodes 110 and 120 include a plurality of positive electrodes 110 and a plurality of negative electrodes 120.

Each positive electrode 110 is formed in a rectangular shape elongated in the width direction W. The width direction W is a direction orthogonal to both the thickness direction T and the height direction H. Each positive electrode 110 includes a positive electrode current collector foil 112 and a positive electrode active material layer 114 provided on both surfaces of the positive electrode current collector foil 112. The positive electrode active material layer 114 is provided on both surfaces of the positive electrode current collector foil 112. The positive electrode current collector foil 112 has a positive electrode tab 112p (see FIG. 2). The positive electrode tab 112p is not provided with the positive electrode active material layer 114. The positive electrode tab 112p protrudes toward one side in the width direction W.

Each negative electrode 120 is formed in a rectangular shape elongated in the width direction. Each negative electrode 120 includes a negative electrode current collector foil 122 and a negative electrode active material layer 124. The negative electrode active material layer 124 is provided on both surfaces of the negative electrode current collector foil 122. As shown in FIG. 2, the negative electrode current collector foil 122 has a negative electrode tab 122n (see FIG. 2). The negative electrode tab 122n is not provided with the negative electrode active material layer 124. The negative electrode tab 122n protrudes toward the other side in the width direction.

The separator 130 insulates the positive electrode 110 from the negative electrode 120. The separator 130 is made of an insulating material. The separator 130 has minute voids that allow penetration of ions. As shown in FIG. 3, the separator 130 is folded.

The separator 130 has a rectangular shape before being folded. The separator 130 is folded between the electrodes 110 and 120. The separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in one direction. That is, each intervening portion 132a has a function of insulating the positive electrode 110 and the negative electrode 120. Each intervening portion 132a is configured by a rectangular region.

The upper folded portion 132b connects the upper end of one of the plurality of intervening portions 132a and the upper end of the intervening portion 132a of the plurality of intervening portions 132a that is adjacent to the one intervening portion 132a on one side of the plurality of intervening portions 132a in one direction. In the present embodiment, the upper folded portion 132b is disposed above the positive electrode 110.

Each lower folded portion 132c connects a lower end portion of the one intervening portion of the plurality of intervening portions 132a and a lower end portion of the intervening portion 132a adjacent to the one intervening portion on the other side in one direction of the plurality of intervening portions 132a. In the present embodiment, the lower folded portion 132c is disposed below the negative electrode 120. In other words, the negative electrode 120 is disposed on the lower folded portion 132c.

The outermost covering portion 132d collectively covers the upper folded portions 132b and the lower folded portions 132c. More specifically, the outermost covering portion 132d collectively covers all of the electrodes 110 and 120, all of the intervening portions 132a, all of the upper folded portions 132b, and all of the lower folded portions 132c while winding around a central axis parallel to the width direction. The terminal end 132e of the outermost covering portion 132d is set so as not to overlap the positive electrode active material layer 114 and the negative electrode active material layer 124 in one direction. In the present embodiment, the terminal end 132e of the outermost covering portion 132d is provided below each of the electrodes 110 and 120. The peripheral surfaces and bottom surfaces of the plurality of electrodes 110 and 120 and the separator 130 are covered with an insulating film (not shown).

As shown in FIGS. 1 and 2, the case 200 houses the electrode assembly 100. The case 200 contains an electrolyte solution (not shown). The case 200 is sealed. The case 200 is made of a metal such as aluminum or an aluminum alloy.

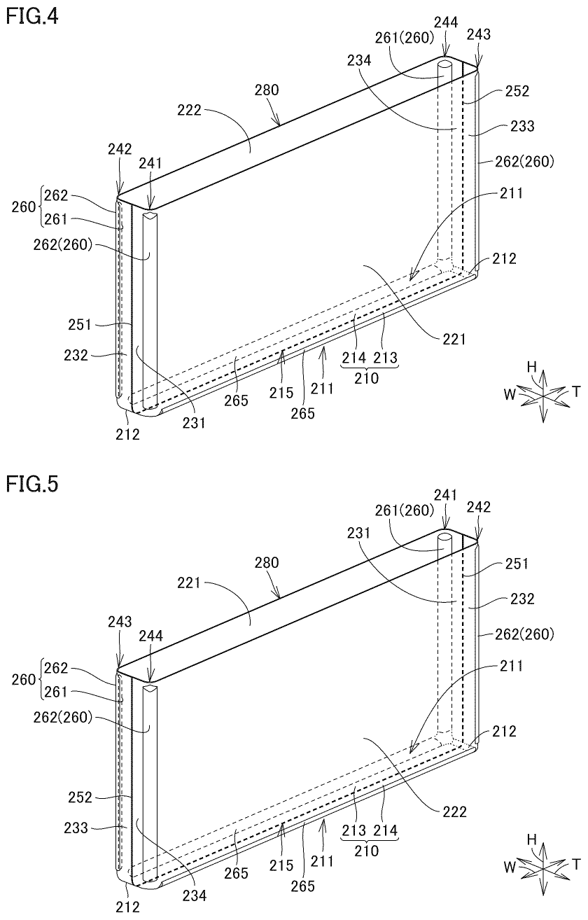

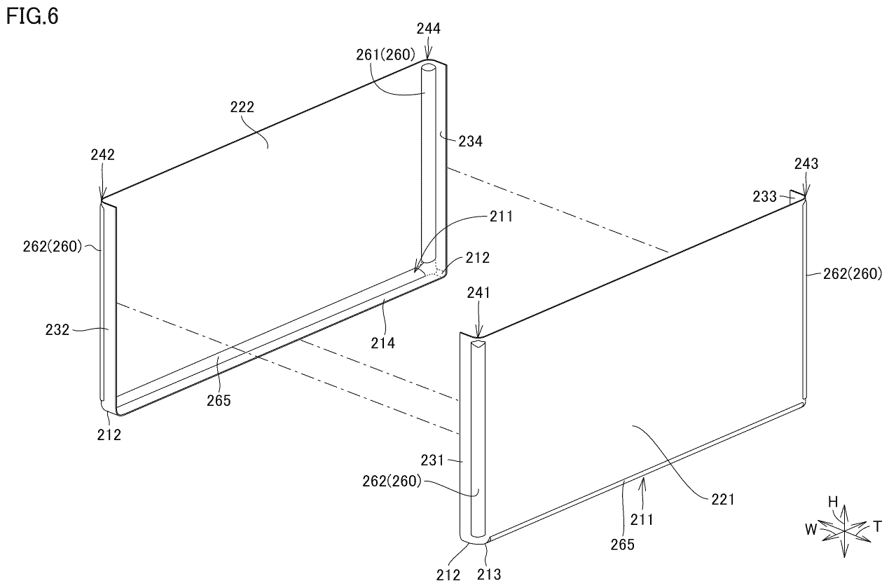

FIG. 4 is a perspective view showing a case according to an embodiment of the present disclosure from one side. FIG. 5 is a perspective view showing a case according to an embodiment of the present disclosure from the other side. FIG. 6 is a schematic perspective view showing a state before each member constituting the case is welded. As shown in FIGS. 1, 2, 4 to 6, the case 200 includes a bottom portion 210, a first side surface portion 221, a second side surface portion 222, a first end face portion 231, a second end face portion 232, a third end face portion 233, a fourth end face portion 234, a first welding portion 251, a second welding portion 252, a plurality of ribs 260, and a lid 270. The lid 270 is not shown in FIGS. 4 to 6.

The bottom portion 210 has a planar outer shape. The bottom portion 210 extends in a plane direction orthogonal to the height direction H. When viewed from the height direction H, the bottom portion 210 has a substantially rectangular outer shape. The bottom portion 210 includes a pair of longer-side portions 211 and a pair of shorter-side portions 212. The length of each of the pair of longer-side portions 211 is longer than the length of each of the pair of shorter-side portions 212.

In this embodiment, the bottom portion 210 includes a first bottom portion 213, a second bottom portion 214, and a bottom welding portion 215. The bottom portion 210 may be integrally formed without having a welding portion.

The first bottom portion 213 and the second bottom portion 214 are arranged in the thickness direction T of the power storage cell 1. The first bottom portion 213 includes one of the pair of longer-side portions 211 and a part of each of the pair of shorter-side portions 212. The second bottom portion 214 includes the other of the pair of longer-side portions 211 and the other of the pair of shorter-side portions.

The bottom welding portion 215 connects the first bottom portion 213 and the second bottom portion 214. The bottom welding portion 215 is formed by welding the edge of the first bottom portion 213 and the edge of the second bottom portion 214 to each other (see FIG. 6). The bottom welding portion 215 extends along the width direction W of the power storage cell 1.

The first side surface portion 221 extends upright from the bottom portion 210. The direction in which the first side surface portion 221 extends upright is the height direction H. Specifically, the first side surface portion 221 extends upright from one of the pair of longer-side portions 211. In the present embodiment, the first side surface portion 221 and the bottom portion 210 are integrally molded without being welded. The first side surface portion 221 and the bottom portion 210 may be connected to each other by welding.

The second side surface portion 222 extends upright from the bottom portion 210 while facing the first side surface portion 221. Therefore, the direction in which the second side surface portion 222 extends upright is also the height direction H. Specifically, the second side surface portion 222 extends upright from the other of the pair of longer-side portions 211. In this embodiment, the second side surface portion 222 and the bottom portion 210 are integrally molded without being welded. The second side surface portion 222 and the bottom portion 210 may be connected to each other by welding.

The first end face portion 231 extends from the first side surface portion 221 along a direction in which the first side surface portion 221 faces the second side surface portion 222. This direction is one of the thickness directions T.

In this embodiment, the first end face portion 231 extends upright from the bottom portion 210. Specifically, the first end face portion 231 extends upright from one of the pair of shorter-side portions 212. The first end face portion 231 extends upright from the first bottom portion 213. The first end face portion 231 and the first bottom portion 213 are integrally molded without being welded. The first end face portion 231 and the first bottom portion 213 may be connected to each other by welding.

The second end face portion 232 extends from the second side surface portion 222 along a direction in which the second side surface portion 222 faces the first side surface portion 221. This direction is the other direction of the thickness direction T.

In this embodiment, the second end face portion 232 extends upright from the bottom portion 210. Specifically, the second end face portion 232 extends upright from one of the pair of shorter-side portions 212. The second end face portion 232 extends upright from the second bottom portion 214. The second end face portion 232 and the second bottom portion 214 are integrally molded without being welded. The second end face portion 232 and the second bottom portion 214 may be connected to each other by welding.

The third end face portion 233 extends from the first side surface portion 221 along a direction in which the first side surface portion 221 faces the second side surface portion 222. This direction is one of the thickness directions T. The third end face portion 233 faces the first end face portion 231 in the width direction W.

In this embodiment, the third end face portion 233 extends upright from the bottom portion 210. Specifically, the third end face portion 233 extends upright from the other of the pair of shorter-side portions 212. The third end face portion 233 extends upright from the first bottom portion 213. The third end face portion 233 and the first bottom portion 213 are integrally formed without being welded. The third end face portion 233 and the first bottom portion 213 may be connected to each other by welding.

The fourth end face portion 234 extends from the second side surface portion 222 along a direction in which the second side surface portion 222 faces the first side surface portion 221. This direction is the other direction of the thickness direction T. The fourth end face portion 234 faces the second end face portion 232 in the width direction W.

In this embodiment, the fourth end face portion 234 extends upright from the bottom portion 210. Specifically, the fourth end face portion 234 extends upright from the other of the pair of shorter-side portions 212. The fourth end face portion 234 extends upright from the second bottom portion 214. The fourth end face portion 234 and the second bottom portion 214 are integrally molded without being welded. The fourth end face portion 234 and the second bottom portion 214 may be connected to each other by welding.

In the case 200, a first corner edge 241 is formed by the first side surface portion 221 and the first end face portion 231. The second side surface portion 222 and the second end face portion 232 form a second corner edge 242. The first side surface portion 221 and the third end face portion 233 form a third corner edge 243. A fourth corner edge 244 is formed by the second side surface portion 222 and the fourth end face portion 234. These corner edges are all rounded.

The first welding portion 251 connects the first end face portion 231 and the second end face portion 232. The first welding portion 251 is formed by welding the edge of the first end face portion 231 and the edge of the second end face portion 232 to each other (see FIG. 6). The first welding portion 251 extends in the height direction H. The first welding portion 251 is connected to the bottom welding portion 215.

The second welding portion 252 connects the third end face portion 233 and the fourth end face portion 234. The second welding portion 252 is formed by welding the edge of the third end face portion 233 and the edge of the second fourth end face portion 234 to each other (see FIG. 6). The second welding portion 252 extends in the height direction H. The second welding portion 252 is connected to the bottom welding portion 215.

The ribs 260 are provided in the first corner edge 241, the second corner edge 242, the third corner edge 243, and the fourth corner edge 244. Each of the ribs 260 extends in the height direction H. Each of the plurality of ribs 260 includes an inner rib 261. A plurality of inner ribs 261 project from the first corner edge 241, the second corner edge 242, the third corner edge 243, and the fourth corner edge 244 to the inside of the case 200, respectively. Each of the plurality of ribs 260 includes an outer rib 262. The plurality of outer ribs 262 project outward of the case 200 from the first corner edge 241, the second corner edge 242, the third corner edge 243, and the fourth corner edge 244.

The ribs 260 may have other shapes. For example, the rib 260 may be provided such that the thickness (the length in the protruding direction of the rib 260) gradually decreases toward the bottom portion 210 side. The ribs 260 may have a cylindrical profile having an axial direction along the height direction H.

The case 200 further includes a plurality of bottom ribs 265. The plurality of bottom ribs 265 are provided on a pair of longer-side portions 211. Each of the plurality of bottom ribs 265 may be connected to the rib 260 at each of both ends in the width direction W.

The lid 270 closes the open end 280 (see FIGS. 1 and 2). In the case 200, the open end 280 is located on the side opposite to the bottom portion 210 side. The open end 280 is formed by respective end edges of the first side surface portion 221, the second side surface portion 222, the first end face portion 231, the second end face portion 232, the third end face portion 233, and the fourth end face portion 234. The lid 270 is connected to the opening by welding or the like. The lid 270 is formed in a flat plate shape.

The lid 270 is supported by a plurality of ribs 260 (inner ribs 261). Specifically, the lid 270 is supported by a plurality of ribs 260 (inner ribs 261) via a lower insulating portion 520 described later. The lid 270 may be directly supported by a plurality of ribs 260 (inner ribs 261).

The lid 270 includes a pressure release valve 272 and a sealing member 274. The pressure release valve 272 is formed at the center of the lid 270. The pressure release valve 272 is formed to break when the internal pressure of the case 200 becomes equal to or higher than a predetermined pressure. When the pressure release valve 272 breaks, the internal pressure of the case 200 decreases. Since the gas in the case 200 is released to the outside of the case 200 through the pressure release valve 272, the internal pressure of the case 200 decreases.

The sealing member 274 seals the liquid injection port h formed in the lid 270. The liquid injection port h is a through hole in the manufacturing process of the power storage cell 1. The through hole is provided for injecting the electrolyte solution into the case 200. The liquid injection port h is sealed by a sealing member 274. The liquid injection port h is sealed after the electrolyte solution is injected into the case 200. The electrolyte solution is injected through the injection port h.

The pair of external terminals 300 is fixed to the case 200. One of the pair of external terminals 300 is a positive-electrode external terminal. The other of the pair of external terminals 300 is a negative-electrode external terminal. Each external terminal 300 is fixed to the upper surface of the lid 270 via an upper insulating portion 510 described later. Each external terminal 300 is made of a metal such as aluminum.

The pair of connecting members 400 connects the plurality of electrode tabs 112p and 122n to the external terminal 300. One of the connecting members 400 connects the plurality of positive electrode tabs 112p to the positive electrode external terminal 300. The other connecting member 400 connects the plurality of negative electrode tabs 122n to the negative electrode external terminal 300. Each of the pair of connecting members 400 has substantially the same structure. Therefore, one of the connecting members 400 will be described below.

The connecting member 400 includes a current collector tab 410, a sub-tab 420, and a connecting pin 430.

The current collector tab 410 has a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub tab 420 connects the plurality of positive electrode tabs 112p to the current collector tab 410. One end 422 of the sub tab 420 is connected to a plurality of positive electrode tabs 112p by welding or the like. The other end portion 424 of the sub tab 420 is connected to the lateral portion 412 of the current collector tab 410 by welding or the like.

The connecting pin 430 connects the current collector tab 410 and the external terminal 300. The connecting pin 430 connects the upper portion 414 and the external terminal 300. Specifically, the lower end of the connecting pin 430 is connected to the upper portion 414 by welding or the like. The lower end of the connecting pin 430 is connected to the upper portion 414 in a state of being inserted into a through hole formed in the upper portion 414. The upper end of the connecting pin 430 is connected to the external terminal 300 by welding, caulking, or the like. An upper end portion of the connecting pin 430 is inserted into a through hole formed in the external terminal 300 and connected to the external terminal 300.

The insulating member 500 insulates the case 200 from the connecting member 400. The insulating member 500 includes an upper insulating portion 510, a lower insulating portion 520, an insulating tube 530, and an insulating plate 540.

The upper insulating portion 510 is fixed to the upper surface of the lid 270. The upper insulating portion 510 is disposed between the lid 270 and the external terminal 300. The upper insulating portion 510 is provided with an insertion hole through which the connecting pin 430 is inserted.

The lower insulating portion 520 is fixed to the lower surface of the lid 270. The lower insulating portion 520 is disposed between the lid 270 and the lower portion of the upper portion 414 and the connecting pin 430. The lower insulating portion 520 is provided with an insertion hole through which the connecting pin 430 is inserted.

The insulating tube 530 is disposed between the connecting pin 430 and the lid 270. The insulating tube 530 is formed in a cylindrical shape and surrounds the connecting pin 430.

The insulating plate 540 is fixed to the lower surface of the upper portion 414. The insulating plate 540 is disposed above the electrode assembly 100. A through hole is formed in a portion of the insulating plate 540 located below the pressure release valve 272 and a portion of the insulating plate 540 located below the liquid injection port h.

The insulating member 500 that insulates one of the pair of connecting members 400 from the case 200 may not include the upper insulating portion 510. The connecting member 400 may be, for example, a connecting member 400 electrically connected to the positive electrode tab 112p. In this case, the external terminal 300 may be in direct contact with the case 200. Another conductive member may be disposed between the external terminal 300 and the case 200 instead of the upper insulating portion 510.

As described above, in the power storage cell 1 according to the embodiment of the present disclosure, the rib 260 is provided in the first corner edge 241 formed by the first side surface portion 221 and the first end face portion 231.

According to the above configuration, the rigidity of the first corner edge 241 is increased by the rib 260. Thereby, when the first end face portion 231 and the second end face portion 232 are welded to form a welding portion, distortion of the first side surface portion 221 due to deformation of the first end face portion 231 to be welded can be suppressed. Therefore, it is possible to provide the power storage cell 1 in which distortion of the case 200 due to welding of the end face is suppressed. The case 200 is increased in size. Alternatively, if the length of the case 200 is further increased in the width direction W, the welding strain at the time of forming the first welding portion 251 is increased. However, this welding strain can be effectively suppressed by the ribs 260.

In the power storage cell 1 according to the embodiment of the present disclosure, the first welding portion 251 extends in the height direction H in which the first side surface portion 221 extends upright. The ribs 260 extend in the height direction H.

According to the above configuration, the rigidity of the first corner edge 241 can be further increased by the rib 260. Even when the first end face portion 231 and the second end face portion 232 are welded along the height direction H, distortion of the first side surface portion 221 due to deformation of the welded first end face portion 231 can be effectively suppressed. Therefore, it is possible to provide the power storage cell 1 in which distortion of the case 200 due to welding of the end face is further suppressed.

In the power storage cell 1 according to the embodiment of the present disclosure, the rib 260 protrudes from the first corner edge 241 to the inside of the case 200.

According to the above configuration, the rigidity of the first corner edge 241 can be increased while suppressing the increase in the size of the case 200.

In the power storage cell 1 according to the embodiment of the present disclosure, the rib 260 protrudes from the first corner edge 241 to the outside of the case 200.

According to the above configuration, it is possible to increase the rigidity of the first corner edge 241 while suppressing a reduction in the size of the space inside the case 200.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell comprising:
an electrode assembly; and
a case housing the electrode assembly,
the case including:
a bottom portion;
a first side surface portion extending upright from the bottom portion;
a second side surface portion extending upright from the bottom portion and facing the first side surface portion;
a first end face portion extending from the first side surface portion in a direction in which the first side surface portion faces the second side surface portion;
a second end face portion extending from the second side surface portion in a direction in which the second side surface portion faces the first side surface portion;
a welding portion connecting the first end face portion and the second end face portion to each other; and
a rib located along a corner edge formed by the first side surface portion and the first end face portion.

2. The power storage cell according to claim 1, wherein
the welding portion extends in a height direction that is a direction in which the first side surface portion extends upright, and
the rib extends in the height direction.

3. The power storage cell according to claim 1, wherein the rib protrudes inward of the case from the corner edge.

4. The power storage cell according to claim 1, wherein the rib protrudes outward of the case from the corner edge.

5. The power storage cell according to claim 1, wherein
the welding portion extends in a height direction that is a direction in which the first side surface portion extends upright,
the rib extends in the height direction, and
the rib protrudes both inward and outward of the case from the corner edge.
